(19) United States
(12) Patent Application Publication
(10) Pub. No.: US 2025/0343497 A1
(43) Pub. Date: Nov. 6, 2025

(54) ROTATION AMOUNT ESTIMATION DEVICE, ROTATION AMOUNT ESTIMATION METHOD, AND MOTOR CONTROL DEVICE

(71) Applicant: DENSO CORPORATION, Kariya-city (JP)

(72) Inventor: Shozen KUDO, Kariya-city (JP)

(21) Appl. No.: 19/271,442

(22) Filed: Jul. 16, 2025

Related U.S. Application Data
(63) Continuation of application No. PCT/JP2024/000513, filed on Jan. 12, 2024.

(30) Foreign Application Priority Data
Jan. 23, 2023 (JP) 2023-008278

(51) Int. Cl. H02P 23/14

(52) U.S. Cl. CPC H02P 23/14

(57) ABSTRACT

A rotation amount estimation device estimates, based on a motor current, a convergence characteristic curve in a period from when a DC voltage applied to the DC motor changes to when a rotation speed of the DC motor is regarded as having reached a corresponding speed corresponding to the changed DC voltage, calculates an integral value of an induced current in the DC motor corresponding to rotation of the DC motor over the period based on the convergence characteristic curve, and estimates a rotation amount of the DC motor in the period based on the integral value.

### CROSS REFERENCE TO RELATED APPLICATION

The present application is a continuation application of International Patent Application No. PCT/JP2024/000513 filed on Jan. 12, 2024, which designated the U.S. and claims the benefit of priority from Japanese Patent Application No. 2023-008278 filed on Jan. 23, 2023. The entire disclosures of all of the above applications are incorporated herein by reference.

### TECHNICAL FIELD

The present disclosure relates to a rotation amount estimation device, a rotation amount estimation method, and a motor control device.

### BACKGROUND

Conventionally, devices that detect rotation information of a motor are known.

### SUMMARY

According to an aspect of the present disclosure, a rotation amount estimation device is configured to estimate a rotation amount of a brushed DC motor. The rotation amount estimation device comprises: at least one of (i) a circuit and (ii) a processor with a memory storing computer program code executable by the processor. The at least one of the circuit and the processor may be configured to cause the rotation amount estimation device to: estimate, based on a motor current flowing through the DC motor, a convergence characteristic curve in a period from when a DC voltage applied to the DC motor changes to when a rotation speed of the DC motor is regarded as having reached a corresponding speed corresponding to the changed DC voltage, the convergence characteristic curve indicating a characteristic in which the motor current converges to a motor current corresponding to the corresponding speed; calculate an integral value obtained by integrating an induced current flowing through the DC motor corresponding to rotation of the DC motor over the period based on the convergence characteristic curve of the motor current as estimated; and estimate the rotation amount of the DC motor in the period based on the integral value of the induced current as calculated.

### BRIEF DESCRIPTION OF DRAWINGS

FIG. 1 is a schematic configuration view schematically illustrating configurations of a rotation amount estimation device and a motor control device according to a first embodiment.

FIG. 2 is a time chart illustrating changes in signals of respective units, including a motor current, when an operation state of a DC motor is changed from a stopped state to a constant rotation state at a corresponding speed corresponding to an applied DC voltage through a rotational acceleration state.

FIG. 3 is an explanatory view for explaining a method for estimating a convergence characteristic curve of a motor current.

FIG. 4 is a view illustrating an actual induced current integral value.

FIG. 5 is a view illustrating a reference induced current integral value.

FIG. 6 is a flowchart illustrating a process for calculating the rotation amount of a DC motor in a period from when the motor control device according to the first embodiment activates the DC motor to when the rotation speed of the DC motor is regarded as having reached a corresponding speed corresponding to the applied DC voltage.

FIG. 7 is a time chart illustrating changes in signals of respective units, including a motor current, in a case where, while the DC motor is rotating at a constant speed, the DC voltage applied to the DC motor changes to instantaneously increase.

FIG. 8 is a schematic configuration view schematically illustrating configurations of a rotation amount estimation device and a motor control device according to a second embodiment.

FIG. 9 is an explanatory view for explaining a method for calculating, in the second embodiment, the rotation amount of a DC motor in a period from when a DC voltage applied to the DC motor changes to when the DC motor starts to rotate at a corresponding speed corresponding to the changed DC voltage.

FIG. 10 is a view illustrating an actual induced current integral value in the second embodiment.

FIG. 11 is a view illustrating a reference induced current integral value in the second embodiment.

FIG. 12 is a flowchart illustrating a process for the motor control device according to the second embodiment calculating the rotation amount of a DC motor in a period from when a DC voltage applied to the DC motor changes to when the DC motor starts to rotate at a corresponding speed corresponding to the changed DC voltage.

### DETAILED DESCRIPTION

Hereinafter, examples of the present disclosure will be described.

According to an example of the present disclosure, a device detects, on the basis of a motor drive waveform of a current flowing through a DC motor having brushes, a voltage across the terminals of the motor, or the like, rotation information of the motor.

This device generates a pulse signal of a ripple component from the waveform of the detected motor current. A rotation amount of the motor is estimated based on the pulse signal. A back electromotive voltage is estimated from a motor terminal voltage and the detected motor current. Then, an integral calculation is performed on the back electromotive voltage for each pulse cycle of the pulse signal to obtain an integral value indicating the rotation amount of the motor. The estimated rotation amount of the motor is corrected based on the integral value.

This device obtains a back electromotive voltage Vg according to the following equation 1 on the basis of a motor terminal voltage Vm and a motor current i flowing through the motor. In the equation 1, L represents an internal inductance of the motor, and r represents an internal resistance of the motor:

Vg=Vm−r·i−L. (Equation 1)

However, the internal resistance r of the motor and the like change depending on the temperature of the motor. Therefore, when the temperature of the motor changes, it is difficult to correctly calculate the back electromotive voltage Vg.

In this device, integration of the back electromotive force is repeated for each pulse cycle of the pulse signal. However, when the rotation speed of the motor is low, for example, after the rotation of the motor is started, the ripple component of the motor current also decreases, and hence it is also difficult to accurately obtain the pulse cycle of the pulse signal. Therefore, there is a risk that the integration of the back electromotive force cannot be correctly performed.

For these reasons, it is very difficult to obtain an accurate rotation amount of the motor using the back electromotive force at the start of rotation of the motor, or the like.

According to an example of the present disclosure, a rotation amount estimation device is configured to estimate a rotation amount of a brushed DC motor. The rotation amount estimation device includes: at least one of (i) a circuit and (ii) a processor with a memory storing computer program code executable by the processor. The at least one of the circuit and the processor is configured to cause the rotation amount estimation device to: estimate, based on a motor current flowing through the DC motor, a convergence characteristic curve in a period from when a DC voltage applied to the DC motor changes to when a rotation speed of the DC motor is regarded as having reached a corresponding speed corresponding to the changed DC voltage, the convergence characteristic curve indicating a characteristic in which the motor current converges to a motor current corresponding to the corresponding speed; calculate an integral value obtained by integrating an induced current flowing through the DC motor corresponding to rotation of the DC motor over the period based on the convergence characteristic curve of the motor current as estimated; and estimate the rotation amount of the DC motor in the period based on the integral value of the induced current as calculated.

According to an example of the present disclosure, a rotation amount estimation method is for estimating a rotation amount of a brushed DC motor, and executed by at least one processor. The rotation amount estimation method includes: first estimating, based on a motor current flowing through the DC motor, a convergence characteristic curve in a period from when a DC voltage applied to the DC motor changes to when a rotation speed of the DC motor is regarded as having reached a corresponding speed corresponding to the changed DC voltage, the convergence characteristic curve indicating a characteristic in which the motor current converges to a motor current corresponding to the corresponding speed; first calculating an integral value acquired by integrating an induced current flowing through the DC motor corresponding to rotation of the DC motor over the period based on the convergence characteristic curve of the motor current as estimated; and second estimating the rotation amount of the DC motor in the period based on the integral value of the induced current as calculated.

According to the rotation amount estimation device and the rotation amount estimation method described above, an induced current, instead of a back electromotive force, is used to estimate the rotation amount of a DC motor in a period from when a DC voltage applied to the DC motor changes to when the rotation speed of the DC motor is regarded as having reached a corresponding speed corresponding to the changed DC voltage. When the DC motor rotates, an induced current corresponding to its rotation speed flows through the DC motor. Therefore, by integrating the induced current flowing through the DC motor over the above period, the integral value becomes a value corresponding to the rotation amount of the DC motor. Therefore, the rotation amount of the DC motor in the above period can be estimated based on the integral value of the induced current, and the estimation accuracy can be improved compared to conventional methods.

According to an example of the present disclosure, a motor control device includes the rotation amount estimation device. The at least one of the circuit and the processor is configured to cause the rotation amount estimation device to: detect the rotation amount of the DC motor based on the rotation amount of the DC motor in the period from when the DC voltage applied to the DC motor changes to when the rotation speed of the DC motor is regarded as having reached the corresponding speed corresponding to the changed DC voltage, the rotation amount being estimated by the rotation amount estimation device, and the rotation amount of the DC motor being calculated based on a motor current waveform of the DC motor when the DC motor rotates at the corresponding speed; and control application of a drive current to the DC motor based on the rotation amount of the DC motor as detected.

The motor control device includes the rotation amount estimation device, thereby to enable to estimate the rotation amount of the DC motor in the period from when the DC voltage applied to the DC motor changes to when the rotation speed of the DC motor is regarded to have reached the corresponding speed corresponding to the changed DC voltage with high accuracy. Therefore, the motor control device enables to detect the rotation amount of the motor from the rotation amount of the DC motor as estimated in the period and the rotation amount of the DC motor as calculated based on the motor current waveform of the DC motor when the DC motor rotates at the corresponding speed corresponding to the applied DC voltage with high accuracy. Thus, the motor control device enables to control supply of the drive current to the DC motor based on the rotation amount of the DC motor as detected.

### First Embodiment

Hereinafter, a rotation amount estimation device, a rotation amount estimation method, and a motor control device including the rotation amount estimation device, according to a first embodiment of the present disclosure, will be described in detail with reference to the drawings. Note that the same or similar configurations are denoted by the same reference numerals over a plurality of the drawings, and thus the description thereof may be omitted.

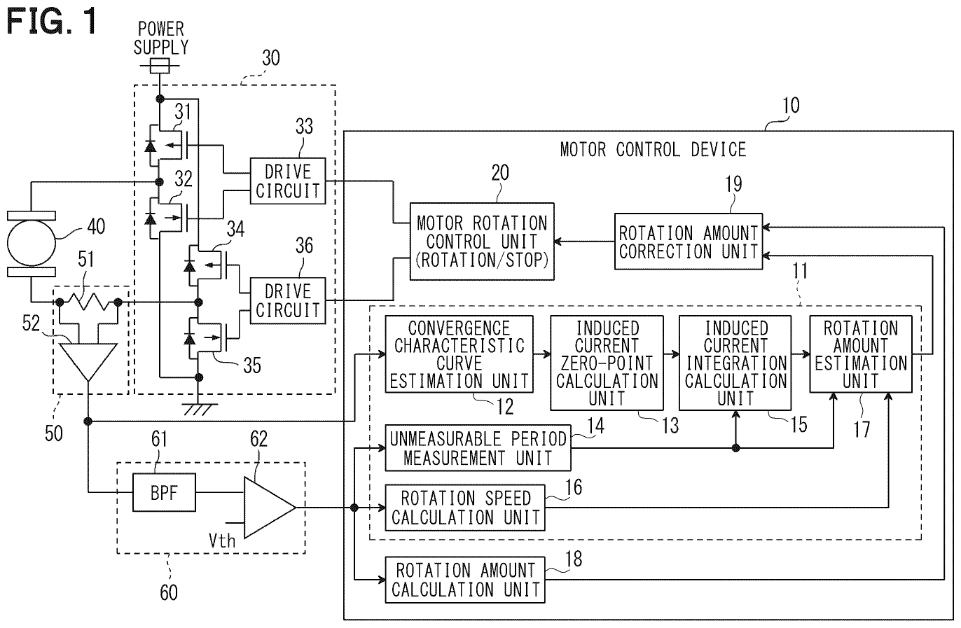

FIG. 1 is a schematic configuration view schematically illustrating configurations of a rotation amount estimation device 11, and a motor control device 10 including the rotation amount estimation device 11, according to the present embodiment. FIG. 1 also illustrates a brushed DC motor (hereinafter, referred to as a DC motor) 40 to be controlled, a motor drive unit 30 that applies a drive current to the DC motor 40 according to a control signal from the motor control device 10, a motor current monitoring unit 50 that detects a current applied to the DC motor 40, and a rotation signal generation unit 60 that generates a rotation signal corresponding to the rotation of the DC motor 40 on the basis of an output signal of the motor current monitoring unit 50.

The DC motor 40 includes, for example, a rotor formed of a laminated iron core around which a coil is wound, and a stator formed of a permanent magnet. When the rotor rotates in a magnetic field, a commutator attached to the rotor also rotates, and brushes with which the commutator is in contact switch places. Every time the brushes with which the commutator is in contact switch places, the direction of the current flowing through the coil is switched, so that the rotor continues to rotate and the DC motor 40 is rotationally driven.

The DC motor 40 can be used as, for example, a motor for opening and closing a window of a vehicle. In addition, the DC motor 40 can be used as an actuator for driving the air mix door in an air conditioner, a door mirror, or the like in a vehicle. Furthermore, the DC motor 40 may be used as an actuator for driving various equipment other than vehicle equipment mounted on a vehicle.

The motor control device 10 according to the present embodiment includes the rotation amount estimation device 11, so that the rotation amount of the DC motor 40 can be estimated with high accuracy in a period from when a DC voltage applied to the DC motor 40 changes, like when the DC motor 40 being stopped is activated or when the power supply voltage changes, to when the rotation speed of the DC motor 40 is regarded as having reached a corresponding speed corresponding to the changed DC voltage, as will be described in detail later. Therefore, even when the DC motor 40 is repeatedly stopped and reactivated, the motor control device 10 can accurately detect the rotational position of the DC motor 40. For these reasons, the motor control device 10 including the rotation amount estimation device 11, according to the present embodiment, is suitable for the application of controlling a DC motor that opens and closes a window of a vehicle.

Here, in a case where the opening and closing of a window of a vehicle is controlled by the DC motor 40, and if pinch by the window occurs while the window is being closed, anti-pinch control for stopping or reversing the DC motor 40 is generally executed. However, there is a risk that, if the anti-pinch control is effective when the window of a vehicle has reached a position where it comes into contact with the window weatherstrip, contact with the window weatherstrip may be erroneously detected as pinch. Therefore, it is necessary to stop (invalidate) the anti-pinch control immediately before the window comes into contact with the window weatherstrip. However, in a case where the position of the window is detected based on the rotation amount of the DC motor 40, and if there is an error in the rotation amount of the DC motor 40, there is a risk that the anti-pinch control cannot be stopped at an appropriate window position such as a position immediately before the window comes into contact with the window weatherstrip. In this regard, in the present embodiment, the rotation amount of the DC motor 40 can be accurately detected even when the stop and the reactivation are repeated, so that the anti-pinch control can be stopped at an appropriate window position. For example, it is only required that when it is determined on the basis of the detected rotation amount of the DC motor 40 that a predetermined distance to the position where the window is closed has been reached, the motor control device 10 stops the anti-pinch control.

The motor drive unit 30 includes four switching elements (e.g., a MOS transistor, an IGBT, and the like) 31, 32, 34, and 35 and two drive circuits 33 and 36. Freewheeling diodes are connected in anti-parallel to the four switching elements 31, 32, 34, and 35, respectively. The four switching elements 31, 32, 34, and 35 form an H-bridge circuit for driving the DC motor 40. The drive circuit 33 controls conduction states (on or off) of the switching elements 31 and 32 according to a control signal from the motor control device 10. The drive circuit 36 controls conduction states of the switching elements 34 and 35 according to a control signal from the motor control device 10.

For example, when rotating the DC motor 40 forward, the motor control device 10 turns on the switching elements 31 and 35 and turns off the switching elements 32 and 34 via the drive circuits 33 and 36. Conversely, when rotating the DC motor 40 in reverse, the motor control device 10 turns on the switching elements 32 and 34 and turns off the switching elements 31 and 35 via the drive circuits 33 and 36. Furthermore, when performing a braking operation to stop the rotation of the DC motor 40 from a normal operation to rotate the DC motor 40 forward or in reverse, the motor control device 10 turns on the switching elements 32 and 35 or the switching elements 31 and 34 via the drive circuits 33 and 36 to apply the same potential (ground potential or power supply potential) to both the terminals of the DC motor 40.

The motor current monitoring unit 50 includes a shunt resistor 51 connected in series with the DC motor 40 in a power supply path for the DC motor 40. Furthermore, the motor current monitoring unit 50 includes a differential amplifier circuit 52 that amplifies the voltage across both terminals of the shunt resistor 51, corresponding to the current applied to the DC motor 40. The output signal amplified by the differential amplifier circuit 52 is input to the motor control device 10 and the rotation signal generation unit 60.

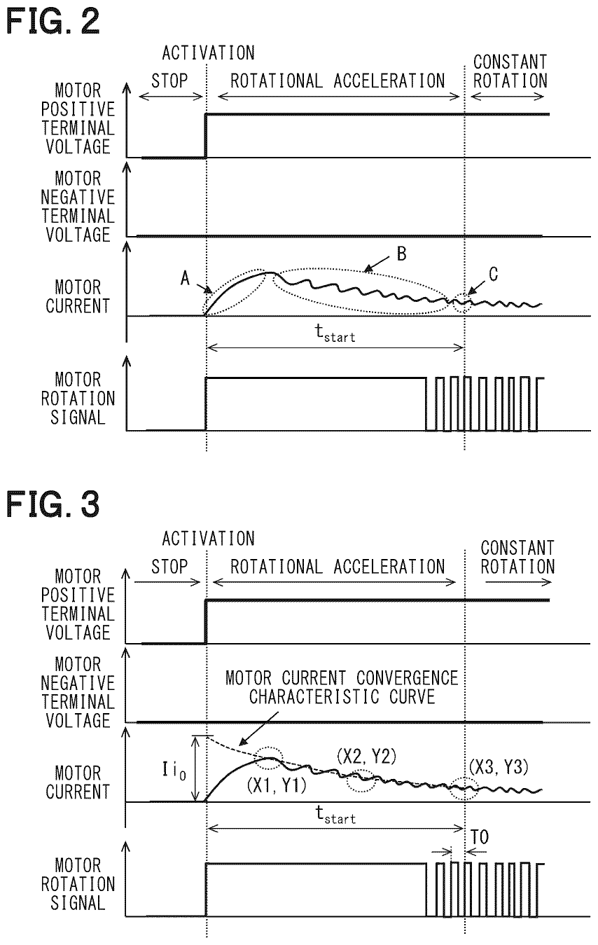

The rotation signal generation unit 60 includes a band-pass filter 61 that performs band-pass filtering on the signal input from the motor current monitoring unit 50. The signal input from the motor current monitoring unit 50 includes a ripple component of the current flowing through the DC motor 40, which is generated every time the DC motor 40 rotates by a predetermined angle, as illustrated as the “motor current” in FIG. 2. The band-pass filter 61 allows a signal in the frequency band of the ripple component to pass through. As a result, the band-pass filter 61 removes noise having a frequency other than the frequency of the ripple component, and outputs a signal corresponding to the ripple component of the current flowing through the DC motor 40.

The rotation signal generation unit 60 further includes a comparator 62 that compares the signal output from the band-pass filter 61 to a threshold Vth. The comparator 62 is configured, for example, to output a Lo-level signal when the output signal from the band-pass filter 61 is larger than the threshold Vth and output a Hi-level signal when the output signal from the band-pass filter 61 is smaller than the threshold Vth. In this case, the comparator 62 outputs a pulse signal that changes from the Hi-level to the Lo-level by a ripple component generated every time the DC motor 40 rotates by a predetermined angle, the Lo-level continuing while the ripple component is larger than the threshold Vth. In the example illustrated in FIG. 2, the pulse signal output from the comparator 62 is illustrated as the “motor rotation signal”.

The motor control device 10 can be configured by a known computer including a CPU as at least one processor, a ROM and a RAM as memories, an I/O circuit for exchanging signals with the outside, and the like. In the motor control device 10, various processes are executed by the CPU according to programs stored, for example, in the ROM. As an example, the motor control device 10 generates and outputs a control signal for controlling the DC motor 40 on the basis of the output signal from the motor current monitoring unit 50 and the motor rotation signal from the rotation signal generation unit 60. The start or stop of the drive of the DC motor 40 is instructed to the motor control device 10 by an external control device, a switch, or the like (not illustrated).

Here, FIG. 1 illustrates, as a block, each function exhibited by the motor control device 10 by executing a program. As illustrated in FIG. 1, the motor control device 10 includes the rotation amount estimation device 11, a rotation amount calculation unit 18, a rotation amount correction unit 19, and a motor rotation control unit 20.

The rotation amount estimation device 11 estimates the rotation amount of the DC motor 40 in a period from when the DC voltage applied to the DC motor 40 changes, like when the motor control device 10 activates the DC motor 40 being stopped, to when the rotation speed of the DC motor 40 is regarded as having reached a corresponding speed corresponding to the changed DC voltage. The rotation amount estimation device 11 will be described in detail later.

The rotation amount calculation unit 18 calculates the rotation amount of the DC motor 40 that has been activated and is rotating at the corresponding speed corresponding to the applied DC voltage, on the basis of the motor rotation signal output by the rotation signal generation unit 60. As described above, the motor rotation signal is a pulse signal that is turned on and off every time the DC motor 40 rotates by a predetermined angle. Therefore, the rotation amount calculation unit 18 can calculate the rotation amount of the DC motor 40 by, for example, counting the number of pulses of the motor rotation signal.

The rotation amount correction unit 19 corrects the rotation amount calculated by the rotation amount calculation unit 18 using the rotation amount of the DC motor 40, provided by the rotation amount estimation device 11, from when the DC motor 40 is activated to when the corresponding speed corresponding to the applied DC voltage is reached. Specifically, the rotation amount correction unit 19 calculates the rotation amount of the DC motor 40 by adding the rotation amount of the DC motor 40 estimated by the rotation amount estimation device 11 to the rotation amount calculated by the rotation amount calculation unit 18. As described above, by adding the rotation amount of the DC motor 40 estimated by the rotation amount estimation device 11 to the rotation amount of the DC motor 40 calculated by the rotation amount calculation unit 18, the rotation amount from when the stopped DC motor 40 is activated and to when the DC motor rotates at the corresponding speed can be accurately detected.

The motor rotation control unit 20 controls the application of a drive current to the DC motor 40 by generating a control signal on the basis of the rotation amount of the DC motor 40 detected by the rotation amount correction unit 19. For example, in a case where the DC motor 40 is used as a motor that opens and closes a window of a vehicle, the motor control device 10 stops the anti-pinch control when it is determined on the basis of the rotation amount of the DC motor 40 detected by the rotation amount correction unit 19 that the window position has reached a predetermined distance to the position where the window is closed. In this case, even when the window comes into contact with the window weatherstrip, the motor rotation control unit 20 can continue the normal operation of the DC motor 40. Then, the motor rotation control unit 20 determines that the window of the vehicle has reached the fully closed position on the basis of, for example, the fact that the window position calculated from the rotation amount detected by the rotation amount correction unit 19 indicates the vicinity of the fully closed position and the motor rotation signal from the rotation signal generation unit 60 has been stopped. When determining that the window has reached the fully closed position, the motor rotation control unit 20 stops the output of the control signal to the motor drive unit 30 and stops the application of the drive current to the DC motor 40. At this time, the rotation amount correction unit 19 preferably has a reset function of resetting, when it is determined that the window of the vehicle has reached the fully closed position, the rotation amount of the DC motor 40 for calculating the window position. This reset function may reset the rotation amount of the DC motor 40 not only when it is determined that the window of the vehicle has reached the fully closed position, but also when it is determined that the window of the vehicle has reached the fully opened position.

When stop of the rotation of the DC motor 40 is instructed to the motor control device 10 by an external control device, a switch, or the like (not illustrated) while the window of the vehicle is being closed, the motor rotation control unit 20 sends a control signal to the motor drive unit 30 so as to stop the application of the drive current to the DC motor 40 and apply the same potential to both the terminals of the DC motor 40. In this case, the rotation of the DC motor 40 stops through the braking operation.

Next, the rotation amount estimation device 11 according to the present embodiment will be described. As described above, the rotation amount estimation device 11 estimates the rotation amount of the DC motor 40 in a period from when the DC voltage applied to the DC motor 40 changes, like when the DC motor 40 being stopped is activated, to when the rotation speed of the DC motor 40 is regarded as having reached a corresponding speed corresponding to the changed DC voltage, by using an induced current instead of a back electromotive force. The magnitude of the induced current corresponds to the rotation speed of the DC motor 40. Therefore, by integrating the induced current over the period from when the DC motor 40 is activated to when it starts to rotate at the corresponding speed corresponding to the applied DC voltage, the integral value becomes a value corresponding to the rotation amount of the DC motor 40 in the period. Therefore, the rotation amount of the DC motor 40 in the period can be estimated on the basis of the integral value of the induced current.

FIG. 2 is a time chart illustrating changes in signals of respective units, including a motor current, when the operation state of the DC motor 40 is changed from a stopped state to a constant rotation state at a corresponding speed corresponding to the applied DC voltage through a rotational acceleration state. In the stopped state, the voltage applied across the positive terminal and the negative terminal of the DC motor 40 is zero, as illustrated in FIG. 2. When a predetermined DC voltage is applied across the positive terminal and the negative terminal of the DC motor 40, the DC motor 40 is activated. That is, a drive current (motor current) flows to the coil of the rotor of the DC motor 40 by the applied DC voltage, and the rotor starts to rotate.

A combined current of the drive current and the induced current flows through the DC motor 40 as the motor current. The drive current and the induced current flow in opposite directions. In addition, the above-described ripple component is generated in the motor current. In the period indicated by “A” in FIG. 2, however, the rotation speed of the DC motor 40 is low, and hence a clear ripple component is not generated. In the period “A”, the rise of the motor current is delayed due to the influence of the inductance of the coil of the DC motor 40. Therefore, the motor current occurring immediately after the activation, that is, occurring when the DC motor 40 does not yet start to rotate and the induced current is zero, cannot be measured from the motor current.

In the period indicated by “B” in FIG. 2, the rotation speed of the DC motor 40 is initially low, and hence interference due to the induced current is small, which makes a relatively large motor current (drive current) flow through the DC motor 40. The higher the rotation speed of the DC motor 40, the larger the induced current, which makes the motor current gradually decrease. In addition, as the rotation speed becomes higher, the ripple component begins to appear in the motor current. In the period “B”, however, the magnitude of the ripple component is relatively small and the motor current itself also changes (decreases), and hence there is a high possibility that the rotation signal generation unit 60 cannot generate an effective motor rotation signal.

At the time point indicated by “C” in FIG. 2, the rotation speed of the DC motor 40 has almost reached the corresponding speed corresponding to the applied DC voltage. At this time, the change in the motor current itself decreases, and the magnitude of the ripple component also increases as the rotation speed becomes higher. Therefore, the rotation signal generation unit 60 can output a motor rotation signal (pulse signal). Conversely, when the rotation signal generation unit 60 can output a motor rotation signal and the rotation speed and/or rotation amount of the DC motor 40 can be calculated from the output motor rotation signal, it can be considered that the rotation speed of the DC motor 40 has reached the corresponding speed corresponding to the applied DC voltage. As illustrated in FIG. 2, the time point indicated by “C” is not the time point at which a pulse signal is output from the rotation signal generation unit 60 for the first time, but the time point at which a plurality of pulse signals are output. This is because the rotation speed and/or rotation amount of the DC motor 40 are calculated from intervals between the plurality of pulse signals.

As described above, the motor current is a combined current of the drive current and the induced current, and the induced current cannot be directly measured from the motor current. Therefore, in the present embodiment, a configuration adopted for integrating the induced current flowing through the DC motor 40 in a period, tₛₜₐᵣₜ, from when a DC voltage is applied to the DC motor 40 being stopped to when the rotation speed of the DC motor 40 is regarded as having reached the corresponding speed corresponding to the applied DC voltage to obtain an integral value of the induced current, and further for estimating the rotation amount of the DC motor 40 in the period, tₛₜₐᵣₜ, on the basis of the integral value of the induced current will be described below.

First, the rotation amount estimation device 11 includes a convergence characteristic curve estimation unit 12. The convergence characteristic curve estimation unit 12 estimates a convergence characteristic curve indicating a characteristic that, in the period, tₛₜₐᵣₜ, from when a DC voltage is applied to the DC motor 40 to when the rotation speed of the DC motor 40 is regarded as having reached the corresponding speed corresponding to the applied DC voltage, the motor current converges to a motor current corresponding to the corresponding speed. The convergence characteristic curve of the motor current is indicated by the dotted line in FIG. 3.

Immediately after the DC voltage is applied to the DC motor 40, the rise of the motor current is delayed due to the inductance of the coil of the DC motor 40, as described above. Whether the motor current exhibits the characteristic of converging to the motor current corresponding to the corresponding speed can be determined on the basis of whether the motor current whose rise is delayed has reached a peak. Therefore, the convergence characteristic curve estimation unit 12 measures the values of the motor currents output from the motor current monitoring unit 50 and the time when each of the values of the motor currents is obtained, at at least three measurement points (X₁, Y₁), (X₂, Y₂), and (X₃, Y₃) after the motor current reaches the peak, as illustrated, for example, in FIG. 3. Note that X₁, X₂, and X₃ represent the times when the respective motor current values are obtained, and Y₁, Y₂, and Y₃ represent the respective motor current values. For example, in the example illustrated in FIG. 3, measurement at the first measurement point (X₁, Y₁) is performed immediately after the motor current reaches the peak. Measurement at the third measurement point (X₃, Y₃) is performed at the time point when the motor current is regarded as having converged to the motor current corresponding to the corresponding speed.

Measurement at the second measurement point (X₂, Y₂) is performed at around the approximate midpoint between the first measurement point (X₁, Y₁) and the third measurement point (X₃, Y₃).

The convergence characteristic curve estimation unit 12 derives the convergence characteristic curve of the motor current on the basis of the measured values at the at least three measurement points (X₁, Y₁), (X₂, Y₂), and (X₃, Y₃). Specifically, the convergence characteristic curve can be represented by a substantially quadratic function curve, as indicated by the dotted line in FIG. 3. Therefore, for example, the quadratic function curve is defined as y=ax²+bx+c, and the measured values at the three measurement points (X₁, Y₁), (X₂, Y₂), and (X₃, Y₃) are substituted into the equation of the quadratic function curve. As a result, the coefficients a, b, and c of the quadratic function curve can be calculated. In this manner, the convergence characteristic curve estimation unit 12 can estimate a convergence characteristic curve indicating a characteristic that the motor current converges to a motor current corresponding to the corresponding speed corresponding to the applied DC voltage.

An induced current zero-point calculation unit 13 calculates, by computation, a value Ii₀ of the motor current, occurring immediately after a DC voltage is applied to the DC motor 40 and when the DC motor 40 is about to start to rotate, from the convergence characteristic curve derived by the convergence characteristic curve estimation unit 12. When the DC motor 40 is about to start to rotate, the value of the induced current is zero because the DC motor 40 does not yet rotate. That is, the induced current zero-point calculation unit 13 calculates, by computation, the motor current value Ii₀ when the value of the induced current is zero.

Here, when the DC voltage applied to the DC motor 40 is constant, the sum of the drive current for driving the DC motor 40 and the induced current generated by the rotation of the DC motor 40 is constant. Therefore, the convergence characteristic curve indicated by the dotted line in FIG. 3 indicates a characteristic that the motor current (drive current), which is maximum at the time point when the DC motor 40 starts to rotate, decreases toward the motor current corresponding to the rotation speed (corresponding speed) of the DC motor 40 corresponding to the DC voltage, while the induced current, which is zero at the time point when the DC motor 40 starts to rotate, increases toward the induced current when the DC motor 40 rotates at the corresponding speed corresponding to the DC voltage.

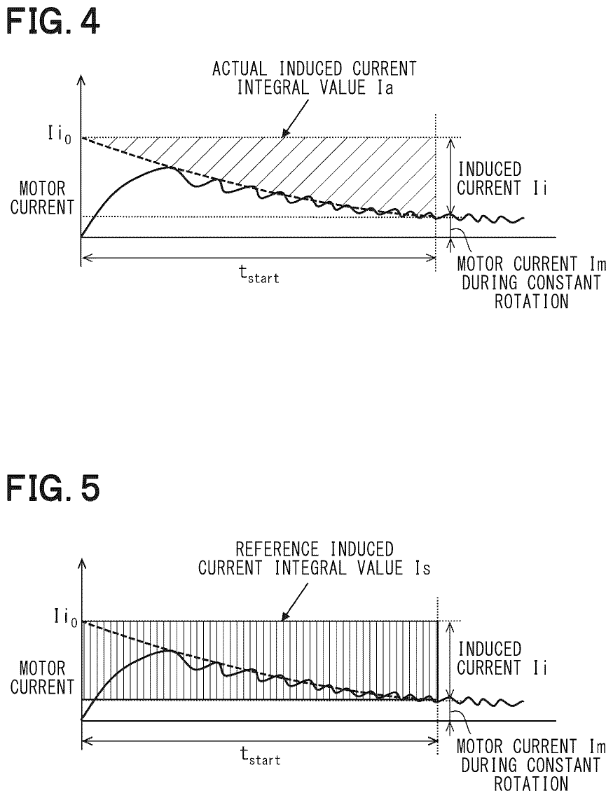

Therefore, by integrating, as indicated by the diagonal lines in FIG. 4, the range surrounded by the motor current value Ii₀ when the value of the induced current is zero and the convergence characteristic curve over the period, tₛₜₐᵣₜ, from when the DC voltage is applied to the DC motor 40 to when the rotation speed of the DC motor 40 is regarded as having reached the corresponding speed corresponding to the applied DC voltage, an integral value Ia of the induced current actually flowing through the DC motor 40 can be obtained.

An unmeasurable period measurement unit 14 measures a period in which the rotation speed and/or rotation amount of the DC motor 40 cannot be calculated from the motor rotation signal generated by the rotation signal generation unit 60, as a period, tₛₜₐᵣₜ, from when the application of the DC voltage to the DC motor 40 is started to when the rotation speed of the DC motor 40 is regarded as having reached the corresponding speed corresponding to the changed DC voltage.

An induced current integration calculation unit 15 calculates an actual induced current integral value Ia indicated by the diagonal lines in FIG. 4 on the basis of the convergence characteristic curve estimated by the convergence characteristic curve estimation unit 12, the motor current value Ii₀ when the value of the induced current calculated by the induced current zero-point calculation unit 13 is zero, and the period, tₛₜₐᵣₜ, measured by the unmeasurable period measurement unit 14.

A rotation speed calculation unit 16 calculates the rotation speed of the DC motor 40 on the basis of the motor rotation signal from the rotation signal generation unit 60.

Based on the rotation speed of the DC motor calculated by the rotation speed calculation unit 16, a rotation amount estimation unit 17 obtains a rotation speed V₀ of the DC motor 40 at the time point when the period, tₛₜₐᵣₜ, measured by the unmeasurable period measurement unit 14 has elapsed. This rotation speed V₀ corresponds to the corresponding speed corresponding to the DC voltage applied to the DC motor 40. For example, the rotation amount estimation unit 17 can set the rotation speed V₀, obtained from a cycle T₀ of the pulse signal immediately before the period, tₛₜₐᵣₜ, elapses and the pulse signal immediately after the period, tₛₜₐᵣₜ, elapses, the rotation speed Vₒ being calculated by the rotation speed calculation unit 16, as the rotation speed of the DC motor 40 at the time point when the period, tₛₜₐᵣₜ, has elapsed, as illustrated in FIG. 3.

In addition, the rotation amount estimation unit 17 calculates a product of the period, tₛₜₐᵣₜ, measured by the unmeasurable period measurement unit 14 and the rotation speed V₀ of the DC motor 40 at the time point when the period, tₛₜₐᵣₜ, has elapsed as a reference rotation amount Ns. That is, the reference rotation amount Ns corresponds to the rotation amount of the DC motor 40 when it is assumed that the DC motor 40 rotates over the time, tₛₜₐᵣₜ, at the corresponding speed (rotation speed V₀) corresponding to the applied DC voltage.

Furthermore, the rotation amount estimation unit 17 calculates a product of the induced current value Ii at the time point when the period, tₛₜₐᵣₜ, has elapsed and the period, tₛₜₐᵣₜ, measured by the unmeasurable period measurement unit 14 as a reference induced current integral value Is, as illustrated in FIG. 5. The induced current value Ii at the time point when the period, tₛₜₐᵣₜ, has elapsed can be obtained by, for example, subtracting a motor current value Im at the time point when the period, tₛₜₐᵣₜ, has elapsed from the motor current value Ii₀ calculated by the induced current zero-point calculation unit 13. As described above, the reference induced current integral value Is corresponds to an integral value of the induced current when it is assumed that the magnitude of the induced current flowing through the DC motor 40, that is, the induced current value Ii at the time point when the period, tₛₜₐᵣₜ, has elapsed is maintained over the period, tₛₜₐᵣₜ.

Then, by multiplying the reference rotation amount Ns by the ratio of the actual induced current integral value Ia to the reference induced current integral value Is, the rotation amount estimation unit 17 calculates the rotation amount Na of the DC motor 40 in the period, tₛₜₐᵣₜ, from when the DC voltage is applied to the DC motor 40 to when the rotation speed of the DC motor 40 is regarded as having reached the corresponding speed corresponding to the applied DC voltage. That is, the rotation amount Na of the DC motor 40 in the period, tₛₜₐᵣₜ, can be calculated by the following equation 2:

Na=Ns×(Ia/Is). (Equation 2)

In the above example, the reference rotation amount Ns and the reference induced current integral value Is are calculated when the DC motor 40 is activated. However, the reference rotation amount Ns and the reference induced current integral value Is need not necessarily be calculated every time the DC motor 40 is activated. For example, regarding the DC motor 40 in question, the reference rotation amounts Ns and the reference induced current integral values Is, corresponding to various motor current values Ii₀ when the DC motor 40 is activated, are examined and stored in the memory in advance. Then, the reference rotation amount Ns and the reference induced current integral value Is, corresponding to the motor current value Ii₀ actually estimated from the convergence characteristic curve, may be selected to obtain the rotation amount Na when the DC motor 40 is activated, according to the above equation 2.

Alternatively, a plurality of pieces of data, related to the actual induced current integral value Ia of the DC motor 40 when the DC motor 40 is activated and the actual rotation amount Na of the DC motor 40, may be measured, and based on the measured data, an equation or a map representing the relationship between the actual induced current integral value Ia and the actual rotation amount Na of the DC motor 40 may be created and stored in the memory. In this case, the actual rotation amount Na of the DC motor 40 can be estimated from the actual induced current integral value Ia using the equation or map stored in the memory.

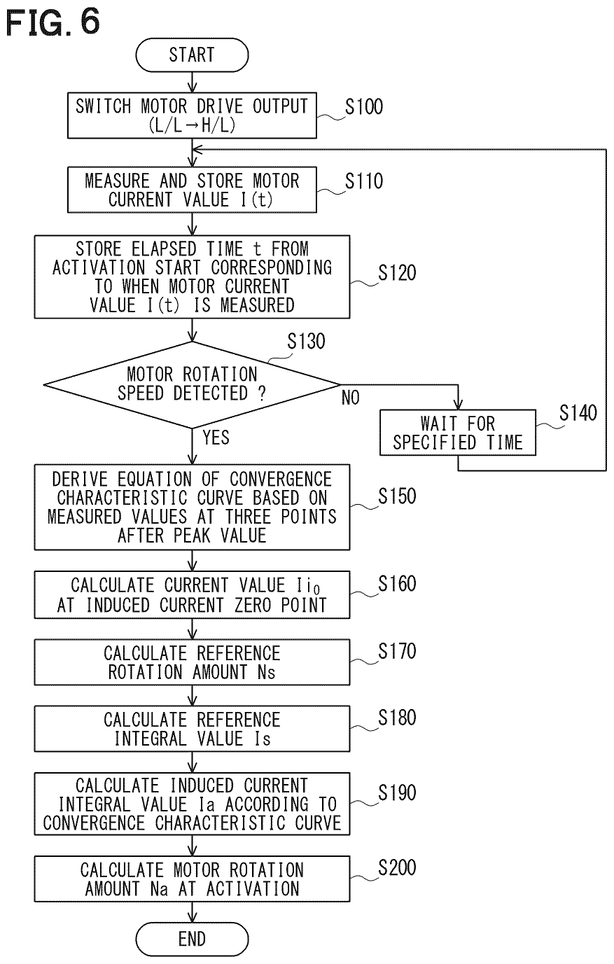

Next, in the motor control device 10, an example of a process executed according to the stored programs will be described with reference to the flowchart of FIG. 6. Note that the process illustrated in the flowchart of FIG. 6 is for calculating the rotation amount Na of the DC motor 40 in the period, tₛₜₐᵣₜ, from when the DC motor 40 is activated to when the rotation speed of the DC motor 40 is regarded as having reached the corresponding speed corresponding to the applied DC voltage. This process is executed when the DC motor 40 is activated.

In a first step S100, the motor control device 10 outputs, to the motor drive unit 30, a control signal for switching from a state in which the same potential is applied to the positive terminal and the negative terminal of the DC motor 40 to a state in which a DC voltage for driving is applied across the positive terminal and the negative terminal of the DC motor 40.

In a step S110, the motor control device 10 measures a motor current value I(t) output from the motor current monitoring unit 50, and stores the value I(t) in the memory. In a step S120, the motor control device 10 acquires an elapsed time t from when the DC motor 40 is activated to when the motor current value I(t) is measured, and stores the elapsed time t in the memory in association with the motor current value I(t). In a step S130, the motor control device 10 determines on the basis of the motor rotation signal from the rotation signal generation unit 60 whether the rotation speed of the DC motor 40 is detected. When determining that the rotation speed of the DC motor 40 is not detected, the motor control device 10 proceeds to a step S140. On the other hand, when determining that the rotation speed of the DC motor 40 is detected, the motor control device 10 proceeds to a step S150. Note that, in the step S130, the elapsed time t when it is determined that the rotation speed of the DC motor 40 has been detected is measured as the period, tₛₜₐᵣₜ, from when the DC motor 40 is activated to when the motor speed becomes detectable on the basis of the motor rotation signal from the rotation signal generation unit 60.

In the step S140, the motor control device 10 waits for a specified time. After waiting for the specified time, the motor control device 10 repeats the processing from the step S110. As a result, in the period, tₛₜₐᵣₜ, from when the DC motor 40 is activated to when the motor speed becomes detectable based on the motor rotation signal from the rotation signal generation unit 60, the motor current value I(t) and the elapsed time t are measured multiple times at specified times. The specified time is set such that the detection of the peak of the motor current and the measurement of the motor current value I(t) when the period, tₛₜₐᵣₜ, elapses can be performed with sufficient accuracy.

In the step S150, the motor control device 10 specifies a peak value of the motor current value I(t) on the basis of a plurality of the measured motor current values I(t). Then, based on the measured values (motor current values I(t) and corresponding elapsed times t) at at least three points measured after the motor current value I(t) reaches the peak value, an equation indicating the convergence characteristic curve of the motor current is derived. The peak value of the motor current value I(t) may or need not be included in the measured values at the at least three points described above.

In a step S160, the motor control device 10 calculates, by computation, the motor current value Ii₀ when the value of the induced current is zero, on the basis of the derived convergence characteristic curve of the motor current. In a step S170, the motor control device 10 calculates, as the reference rotation amount Ns, a product of the period, tₛₜₐᵣₜ, from when the DC motor 40 is activated to when the motor speed becomes detectable on the basis of the motor rotation signal and the rotation speed V₀ of the DC motor 40 at the time point when the period, tₛₜₐᵣₜ, has elapsed. In a step S180, the motor control device 10 calculates a product of the induced current value Ii at the time point when the period, tₛₜₐᵣₜ, has elapsed and the period, tₛₜₐᵣₜ, as the reference induced current integral value Is.

In a step S190, the motor control device 10 integrates, according to the convergence characteristic curve of the motor current derived in the step S150, the range surrounded by the motor current value Ii₀ when the value of the induced current is zero and the convergence characteristic curve over the elapsed time, tₛₜₐᵣₜ, thereby obtaining the actual induced current integral value Ia. Then, in a step S200, the motor control device 10 calculates the rotation amount Na of the DC motor 40 when it is activated, by multiplying the reference rotation amount Ns by the ratio of the actual induced current integral value Ia to the reference induced current integral value Is.

### Second Embodiment

Next, a rotation amount estimation device, a rotation amount estimation method, and a motor control device including the rotation amount estimation device according to a second embodiment of the present disclosure, will be described in detail with reference to the drawings.

In the first embodiment described above, an example has been described in which the rotation amount estimation device 11 calculates the rotation amount Na of the DC motor 40 when the DC voltage applied to the DC motor 40 changes because, when the DC motor 40 is activated, a DC voltage for driving is applied to the stopped DC motor 40. However, the change of the DC voltage applied to the DC motor 40 is not limited only when the motor is activated. For example, in a case where the motor control device 10 is used to drive an in-vehicle device such as a window of a vehicle, the DC voltage supplied from an in-vehicle battery to the DC motor 40 may change as a relatively large in-vehicle electrical load, such as a starter, is turned on and off.

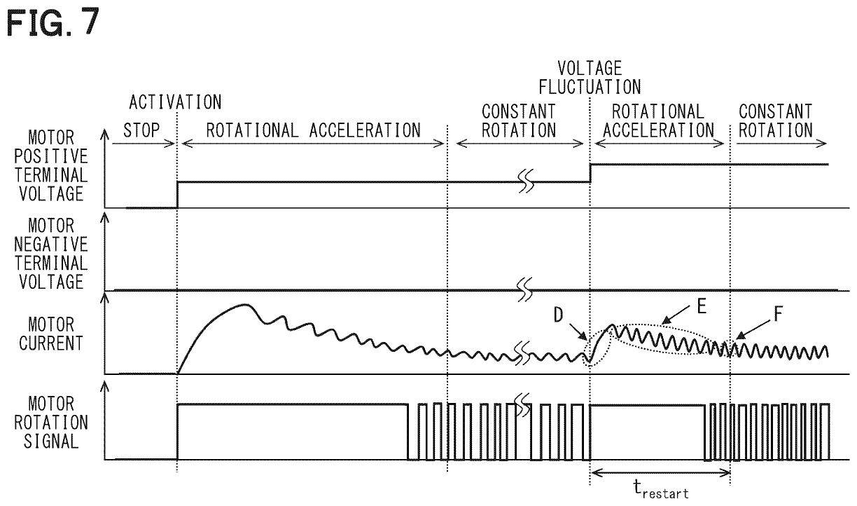

For example, when the DC voltage applied to the DC motor 40 changes with an instantaneous increase while the DC motor 40 is rotating at a constant speed, the motor current changes similarly to that when the DC motor 40 is activated, as illustrated in FIG. 7. That is, in the period indicated by “D” in FIG. 7, the rise in the motor current is delayed with respect to the rise in the DC voltage. In the period indicated by “E” in FIG. 7, a relatively large motor current (drive current) flows through the DC motor 40 due to less interference by the induced current. The higher the rotation speed of the DC motor 40, the larger the induced current, which makes the motor current gradually decrease. In the period “E”, however, the motor current value itself changes (decreases), and hence there is a high risk that the rotation signal generation unit 60 cannot generate an effective motor rotation signal. At the time point indicated by “F” in FIG. 7, the rotation speed of the DC motor 40 has almost reached the corresponding speed corresponding to the changed DC voltage. At this time, a change in the motor current itself decreases. Therefore, the rotation signal generation unit 60 can output a motor rotation signal (pulse signal).

When the DC voltage applied to the DC motor 40 rotating at a constant speed suddenly changes, the rotation amount estimation device according to the present embodiment can estimate the rotation amount of the DC motor 40 in a period, tᵣₑₛₜₐᵣₜ, from when the change occurs to when the motor current converges to a motor current flowing through the DC motor 40 when the DC motor 40 rotates at the corresponding speed corresponding to the changed DC voltage. The rotation amount estimation device according to the present embodiment can estimate the rotation amount of the DC motor 40 not only when the DC voltage suddenly increases but also when the DC voltage suddenly decreases.

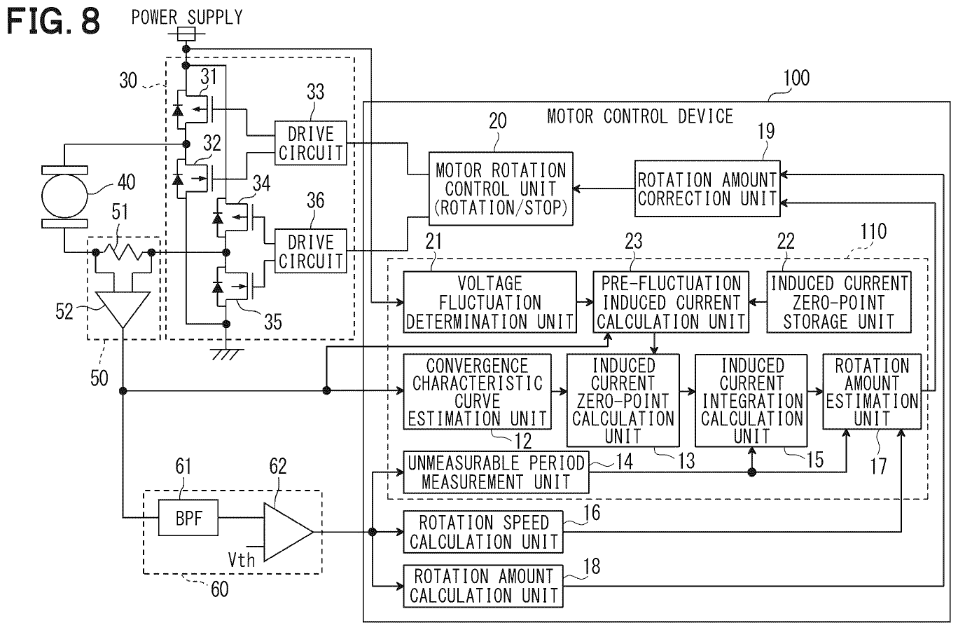

FIG. 8 is a schematic configuration view schematically illustrating configurations of a rotation amount estimation device 110, and a motor control device 100 including the rotation amount estimation device 110, according to the present embodiment. In the rotation amount estimation device 110, a voltage change determination unit 21, an induced current zero-point storage unit 22, and a pre-change induced current calculation unit 23 are added to the configuration of the first embodiment illustrated in FIG. 1. Other configurations are the same as those of the first embodiment illustrated in FIG. 1.

The voltage change determination unit 21 determines whether the DC voltage applied to the DC motor 40 has changed by a predetermined threshold or more. That is, when the DC voltage suddenly increases or decreases by the threshold or more, the voltage change determination unit 21 determines that the DC voltage applied to the DC motor 40 has changed by the predetermined threshold or more.

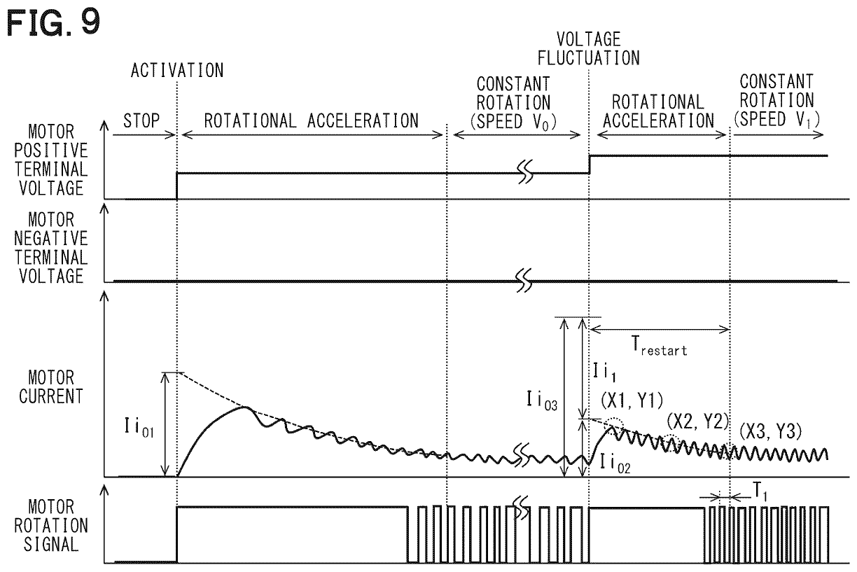

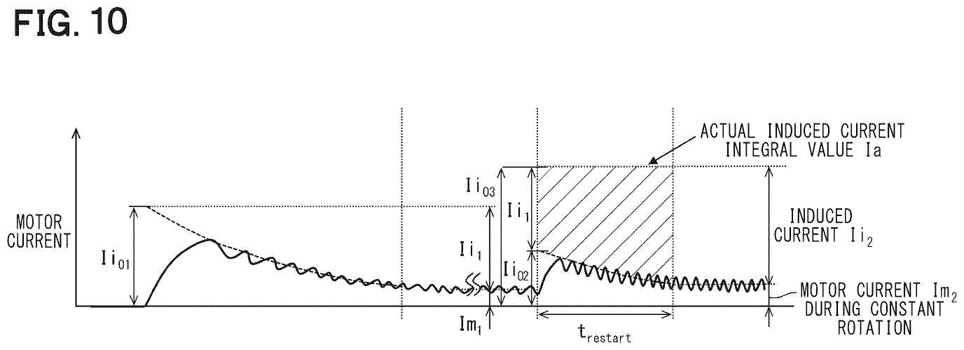

The induced current zero-point storage unit 22 stores a motor current value Ii₀₁ when the induced current is zero, calculated before the DC voltage applied to the DC motor 40 changes and based on the convergence characteristic curve of the motor current (see FIGS. 9 and 10).

The pre-change induced current calculation unit 23 calculates, by computation, an induced current value Ii₁ flowing through the DC motor 40 before the DC voltage applied to the DC motor 40 changes. Specifically, the pre-change induced current calculation unit 23 calculates the induced current value Ii₁ before the DC voltage changes, by subtracting a motor current value Im₁ immediately before the DC voltage applied to the DC motor 40 changes, from the motor current value Ii₀₁ when the induced current is zero, which is stored in the induced current zero-point storage unit 22 (see FIG. 10).

When the induced current value Ii₁ before the DC voltage changes is provided from the pre-change induced current calculation unit 23, the induced current zero-point calculation unit 13 adds the induced current value Ii₁ before the DC voltage changes to a motor current value Ii₀₂ when the induced current calculated from the convergence characteristic curve of the motor current, estimated by the convergence characteristic curve estimation unit 12, is zero, thereby calculating a motor current value Ii₀₃ at an induced current zero point, as illustrated in FIGS. 9 and 10.

Then, the induced current integration calculation unit 15 calculates an actual induced current integral value Ia indicated by the diagonal lines in FIG. 10 on the basis of the convergence characteristic curve estimated by the convergence characteristic curve estimation unit 12, the motor current value Ii₀₃ when the induced current value calculated by the induced current zero-point calculation unit 13 is zero, and the period, tᵣₑₛₜₐᵣₜ, measured by the unmeasurable period measurement unit 14.

Based on the rotation speed of the DC motor 40 calculated by the rotation speed calculation unit 16, the rotation amount estimation unit 17 obtains a rotation speed V₁ of the DC motor 40 at the time point when the period, tᵣₑₛₜₐᵣₜ, measured by the unmeasurable period measurement unit 14 has elapsed. For example, the rotation amount estimation unit 17 sets the rotation speed V₁, calculated by the rotation speed calculation unit 16 and obtained from a cycle T₁ between the pulse signal immediately before the period, tᵣₑₛₜₐᵣₜ, elapses and the pulse signal immediately after the period, tᵣₑₛₜₐᵣₜ, elapses, as the rotation speed of the DC motor 40 at the time point when the period, tᵣₑₛₜₐᵣₜ, has elapsed, as illustrated in FIG. 9.

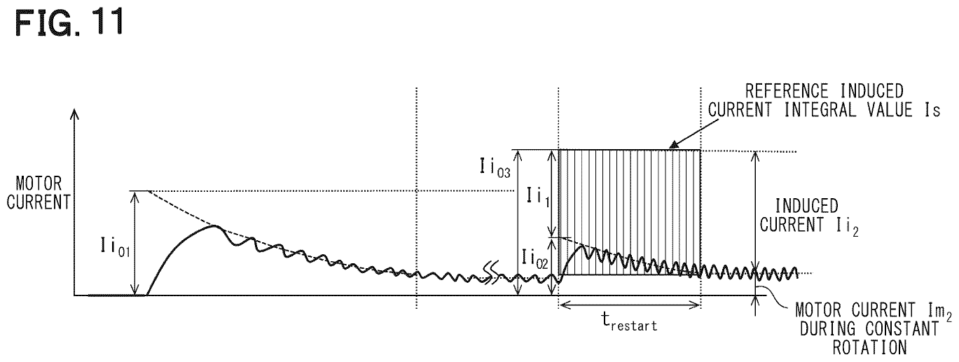

In addition, the rotation amount estimation unit 17 calculates a product of the period, tᵣₑₛₜₐᵣₜ, measured by the unmeasurable period measurement unit 14 and the rotation speed V₁ of the DC motor 40 at the time point when the period, tᵣₑₛₜₐᵣₜ, has elapsed as a reference rotation amount Ns. Furthermore, the rotation amount estimation unit 17 calculates a product of the induced current value Ii₂ at the time point when the period, tᵣₑₛₜₐᵣₜ, has elapsed and the period, tᵣₑₛₜₐᵣₜ, measured by the unmeasurable period measurement unit 14 as a reference induced current integral value Is, as illustrated in FIG. 11. The induced current value Ii₂ at the time point when the period, tᵣₑₛₜₐᵣₜ, has elapsed can be obtained by subtracting a motor current value Im₂ at the time point when the period, tᵣₑₛₜₐᵣₜ, has elapsed from the motor current value Ii₀₃ calculated by the induced current zero-point calculation unit 13.

Then, by multiplying the reference rotation amount Ns by the ratio of the actual induced current integral value Ia to the reference induced current integral value Is, the rotation amount estimation unit 17 calculates the rotation amount Na of the DC motor 40 in the period, tᵣₑₛₜₐᵣₜ, from when the DC voltage is applied to the DC motor 40 to when the rotation speed of the DC motor 40 is regarded as having reached the corresponding speed corresponding to the applied DC voltage.

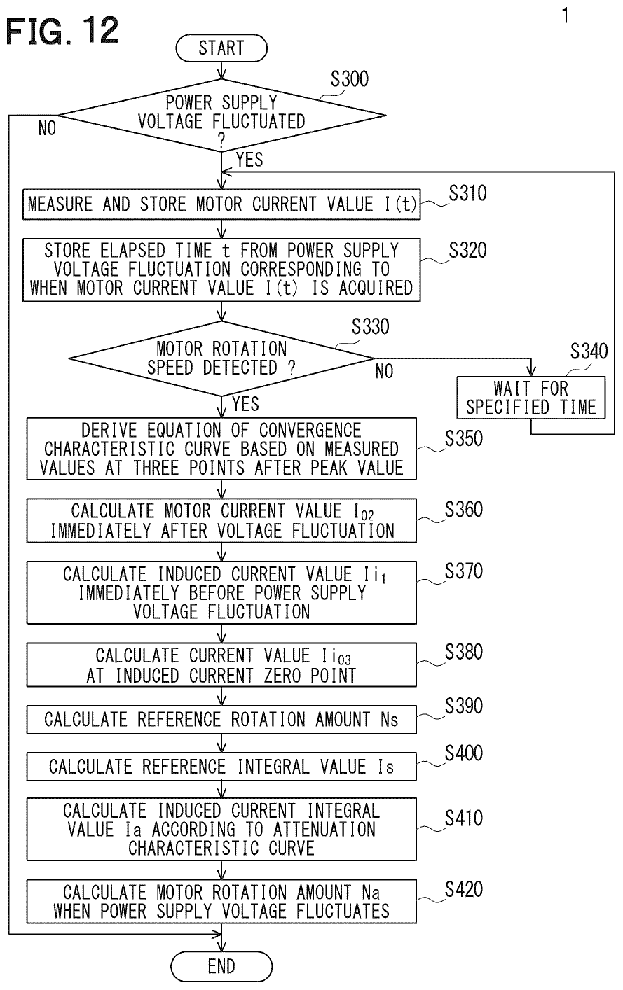

Next, in the motor control device 100, an example of a process executed according to the stored programs will be described with reference to the flowchart of FIG. 12. Note that the process illustrated in the flowchart of FIG. 12 is for calculating, when the DC voltage applied to the DC motor 40 suddenly changes, the rotation amount Na of the DC motor 40 in the period, tᵣₑₛₜₐᵣₜ, from when the change occurs to when the motor current converges to the motor current flowing through the DC motor 40 rotating at the corresponding speed corresponding to the changed DC voltage. The process illustrated in the flowchart of FIG. 12 is executed periodically, for example, at a predetermined cycle.

In a first step S300, the motor control device 100 determines whether the voltage of the power supply that supplies a DC voltage to the DC motor 40 has changed by a predetermined threshold or more. When the power supply voltage has changed by a predetermined threshold or more, the motor control device 100 proceeds to the processing of a step S310. When the power supply voltage has not changed by the predetermined threshold or more, the process illustrated in the flowchart of FIG. 12 ends.

Note that the motor control device 100 may be configured to execute the processing from the step S310 and beyond on condition that the unmeasurable period measurement unit 14 cannot correctly calculate the rotation speed and/or the rotation amount of the DC motor 40 from the motor rotation signal generated by the rotation signal generation unit 60, in addition to or instead of the change of the power supply voltage.

Since steps S310 through S360 are similar to the steps S110 through S160 of the flowchart of FIG. 6, the description thereof is omitted.

In a step S370, the motor control device 100 calculates, by computation, the induced current value Ii₁ flowing through the DC motor 40 before the DC voltage applied to the DC motor 40 changes. That is, the motor control device 10 subtracts the motor current value Im₁ immediately before the DC voltage applied to the DC motor 40 changes from the motor current value Ii₀₁ when the stored induced current is zero, thereby calculating the induced current value Ii₁ before the DC voltage changes.

In a step S380, the motor control device 100 adds the induced current value Ii₁ before the DC voltage changes to the motor current value Ii₀₂ when the induced current calculated from the convergence characteristic curve of the motor current is zero, thereby calculating the motor current value Ii₀₃ at the induced current zero point.

In a step S390, the motor control device 100 calculates a product of the rotation speed V₁ of the DC motor 40 at the time point when the period, tᵣₑₛₜₐᵣₜ, has elapsed and the period, tᵣₑₛₜₐᵣₜ, as the reference rotation amount Ns. In a step S400, the motor control device 100 calculates a product of the induced current value Ii₂ at the time point when the period, tᵣₑₛₜₐᵣₜ, has elapsed and the period, tᵣₑₛₜₐᵣₜ, as the reference induced current integral value Is. In a step S410, the motor control device 100 calculates the actual induced current integral value Ia on the basis of the convergence characteristic curve of the DC motor 40, the motor current value Ii₀₃ when the value of the induced current is zero, and the period, tᵣₑₛₜₐᵣₜ. Then, in a step S420, the motor control device 100 multiplies the reference rotation amount Ns by the ratio of the actual induced current integral value Ia to the reference induced current integral value Is, thereby calculating the rotation amount Na of the DC motor 40 in the period, tᵣₑₛₜₐᵣₜ, from when the DC voltage is applied to the DC motor 40 to when the rotation speed of the DC motor 40 is regarded as having reached the corresponding speed corresponding to the applied DC voltage.

Although preferred embodiments of the present disclosure have been described above, the present disclosure is not limited to the above-described embodiments. In other words, the present disclosure can be variously modified and implemented without departing from the gist of the present disclosure described in the claims.

For example, in the first and second embodiments described above, the motor control device 10 and 100 may be configured to include a stop suspension unit that maintains the rotation of the DC motor 40 until the calculation of the rotation amount of the DC motor 40 in the period, tₛₜₐᵣₜ, or the period, tᵣₑₛₜₐᵣₜ, from when the DC voltage applied to the DC motor 40 changes to when the rotation speed of the DC motor 40 is regarded as having reached the corresponding speed corresponding to the changed DC voltage, is completed, even when stop of the rotation of the DC motor 40 is instructed. As a result, the motor control devices 10 and 100 can correctly calculate the rotation amount of the DC motor 40 when the DC voltage changes regardless of a rotation stop instruction for the DC motor 40.

What is claimed is:

1. A rotation amount estimation device configured to estimate a rotation amount of a brushed DC motor, the rotation amount estimation device comprising:
at least one of (i) a circuit and (ii) a processor with a memory storing computer program code executable by the processor, the at least one of the circuit and the processor configured to cause the rotation amount estimation device to:
estimate, based on a motor current flowing through the DC motor, a convergence characteristic curve in a period from when a DC voltage applied to the DC motor changes to when a rotation speed of the DC motor is regarded as having reached a corresponding speed corresponding to the changed DC voltage, the convergence characteristic curve indicating a characteristic in which the motor current converges to a motor current corresponding to the corresponding speed;
calculate an integral value obtained by integrating an induced current flowing through the DC motor corresponding to rotation of the DC motor over the period based on the convergence characteristic curve of the motor current as estimated; and
estimate the rotation amount of the DC motor in the period based on the integral value of the induced current as calculated.

2. The rotation amount estimation device according to claim 1, wherein
the at least one of the circuit and the processor is configured to cause the rotation amount estimation device to:
generate a pulse signal corresponding to the rotation of the DC motor based on a ripple component included in the motor current of the DC motor; and
regard the rotation speed of the DC motor as having reached the corresponding speed corresponding to the changed DC voltage, when the rotation speed or the rotation amount of the DC motor becomes detectable from the pulse signal as generated.

3. The rotation amount estimation device according to claim 1, wherein
the at least one of the circuit and the processor is configured to cause the rotation amount estimation device to derive the convergence characteristic curve based on motor current values at at least three points acquired in the period and times when the motor current values at the at least three points are acquired.

4. The rotation amount estimation device according to claim 3, wherein
the at least one of the circuit and the processor is configured to cause the rotation amount estimation device to derive the convergence characteristic curve that is a quadratic function curve.

5. The rotation amount estimation device according to claim 3, wherein
the at least one of the circuit and the processor is configured to cause the rotation amount estimation device to acquire the motor current values at the at least three points and the times when the motor current values at the at least three points are acquired, after the motor current reaches a peak value.

6. The rotation amount estimation device according to claim 1, wherein
the at least one of the circuit and the processor is configured to cause the rotation amount estimation device to estimate the convergence characteristic curve in a first period from when a DC voltage for rotating the DC motor is applied to the DC motor being stopped to when the rotation speed of the DC motor is regarded as having reached the corresponding speed corresponding to the DC voltage.

7. The rotation amount estimation device according to claim 6, wherein
the at least one of the circuit and the processor is configured to cause the rotation amount estimation device to:
calculate, as a reference rotation amount, a product of the corresponding speed and the first period;
calculate, as a reference integral value, a product of an induced current when the DC motor rotates at the corresponding speed and the first period, the induced current being calculated by subtracting a motor current corresponding to the corresponding speed from a motor current immediately after the DC voltage is applied to the DC motor and estimated from the convergence characteristic curve; and
calculate the rotation amount of the DC motor in the first period by multiplying the reference rotation amount by a ratio of the integral value of the induced current in the first period to the reference integral value.

8. The rotation amount estimation device according to claim 1, wherein
the at least one of the circuit and the processor is configured to cause the rotation amount estimation device to estimate the convergence characteristic curve in a second period from when a changed DC voltage is applied to the DC motor, which rotates at the corresponding speed corresponding to the DC voltage before the change, to when the rotation speed of the DC motor is regarded as having reached the corresponding speed corresponding to the changed DC voltage.

9. The rotation amount estimation device according to claim 8, wherein
the at least one of the circuit and the processor is configured to cause the rotation amount estimation device to:
calculate, as a reference rotation amount, a product of the corresponding speed corresponding to the changed DC voltage and the second period;
calculate, as a reference integral value, a product of an induced current when the DC motor rotates at the corresponding speed corresponding to the changed DC voltage and the second period, the induced current being calculated by subtracting the motor current, which corresponds to the corresponding speed corresponding to the changed DC voltage, from a sum of a motor current, which is immediately after the changed DC voltage is applied to the DC motor, and an induced current, which flows through the DC motor rotating at the corresponding speed corresponding to the DC voltage before the change, as estimated from the convergence characteristic curve; and
calculate the rotation amount of the DC motor in the second period by multiplying the reference rotation amount by a ratio of the integral value of the induced current in the second period to the reference integral value.

10. The rotation amount estimation device according to claim 8, wherein
the at least one of the circuit and the processor is configured to cause the rotation amount estimation device to:
determine change in the DC voltage applied to the DC motor; and
execute a process for calculating the rotation amount of the DC motor in the second period when determining that the DC voltage has changed beyond a predetermined threshold.

11. The rotation amount estimation device according to claim 8, wherein
the at least one of the circuit and the processor is configured to cause the rotation amount estimation device to:
generate a pulse signal corresponding to the rotation of the DC motor based on a ripple component included in the motor current of the DC motor; and
execute a process for calculating the rotation amount of the DC motor in the second period on condition that the rotation speed or the rotation amount of the DC motor cannot be detected from the pulse signal as generated.

12. The rotation amount estimation device according to claim 1, wherein
the at least one of the circuit and the processor is configured to cause the rotation amount estimation device to maintain the rotation of the DC motor until calculation of the rotation amount of the DC motor in the period from when the DC voltage applied to the DC motor changes to when the rotation speed of the DC motor is regarded as having reached the corresponding speed corresponding to the changed DC voltage is completed, even when the rotation of the DC motor is instructed to stop.

13. A motor control device comprising:
the rotation amount estimation device according to claim 1, wherein
the at least one of the circuit and the processor is configured to cause the rotation amount estimation device to:
detect the rotation amount of the DC motor based on the rotation amount of the DC motor in the period from when the DC voltage applied to the DC motor changes to when the rotation speed of the DC motor is regarded as having reached the corresponding speed corresponding to the changed DC voltage, the rotation amount being estimated by the rotation amount estimation device, and the rotation amount of the DC motor being calculated based on a motor current waveform of the DC motor when the DC motor rotates at the corresponding speed; and
control application of a drive current to the DC motor based on the rotation amount of the DC motor as detected.

14. The motor control device according to claim 13, wherein
the DC motor is configured to open and close a window of a vehicle, and
the at least one of the circuit and the processor is configured to cause the rotation amount estimation device to:
when pinch by the window occurs while the window is being closed, execute anti-pinch control for stopping or reversing the DC motor; and
when determining that a position of the window, which is calculated based on the rotation amount of the DC motor as detected, has reached a predetermined distance to a closing position where the window is closed, stop the anti-pinch control.

15. The motor control device according to claim 14, wherein
the at least one of the circuit and the processor is configured to cause the rotation amount estimation device to reset the rotation amount of the DC motor for calculating the position of the window, when the window reaches the closing position or an opening position.

16. A rotation amount estimation method for estimating a rotation amount of a brushed DC motor, executed by at least one processor, the rotation amount estimation method comprising:
first estimating, based on a motor current flowing through the DC motor, a convergence characteristic curve in a period from when a DC voltage applied to the DC motor changes to when a rotation speed of the DC motor is regarded as having reached a corresponding speed corresponding to the changed DC voltage, the convergence characteristic curve indicating a characteristic in which the motor current converges to a motor current corresponding to the corresponding speed;
first calculating an integral value acquired by integrating an induced current flowing through the DC motor corresponding to rotation of the DC motor over the period based on the convergence characteristic curve of the motor current as estimated; and
second estimating the rotation amount of the DC motor in the period based on the integral value of the induced current as calculated.

17. The rotation amount estimation method according to claim 16, further comprising:
generating a pulse signal corresponding to the rotation of the DC motor based on a ripple component included in the motor current of the DC motor, wherein
the first estimating includes regarding the rotation speed of the DC motor as having reached a corresponding speed corresponding to the changed DC voltage, when the rotation speed or the rotation amount of the DC motor becomes detectable from the pulse signal as generated.

18. The rotation amount estimation method according to claim 16, wherein,
the first estimating includes deriving the convergence characteristic curve based on motor current values at at least three points measured in the period and times when the motor current values at the at least three points are acquired.

19. The rotation amount estimation method according to claim 18, wherein
the first estimating includes deriving the convergence characteristic curve that is a quadratic function curve.

20. The rotation amount estimation method according to claim 18, wherein,
the first estimating includes acquiring the motor current values at the at least three points and the times when the motor current values at the at least three points, after the motor current reaches a peak value.

21. The rotation amount estimation method according to claim 16, wherein
the first estimating includes estimating the convergence characteristic curve in a first period from when the DC voltage for rotating the DC motor is applied to the DC motor being stopped to when the rotation speed of the DC motor is regarded as having reached the corresponding speed corresponding to the DC voltage.

22. The rotation amount estimation method according to claim 21, wherein
the second estimating includes:
second calculating, as a reference rotation amount, a product of the corresponding speed and the first period;
third calculating, as a reference integral value, a product of an induced current when the DC motor rotates at the corresponding speed and the first period, the induced current being calculated by subtracting a motor current corresponding to the corresponding speed from a motor current immediately after the DC voltage is applied to the DC motor and estimated from the convergence characteristic curve; and
fourth calculating the rotation amount of the DC motor in the first period by multiplying the reference rotation amount by a ratio of the integral value of the induced current in the first period to the reference integral value.

23. The rotation amount estimation method according to claim 16, wherein
the first estimating includes estimating the convergence characteristic curve in a second period from when the changed DC voltage is applied to the DC motor rotating at the corresponding speed corresponding to the DC voltage before the change to when the rotation speed of the DC motor is regarded as having reached the corresponding speed corresponding to the changed DC voltage.

24. The rotation amount estimation method according to claim 23, wherein
the second estimating includes:
fifth calculating, as a reference rotation amount, a product of the corresponding speed corresponding to the changed DC voltage and the second period;
sixth calculating, as a reference integral value, a product of an induced current when the DC motor rotates at the corresponding speed corresponding to the changed DC voltage and the second period, the induced current being calculated by subtracting the motor current, which corresponds to the corresponding speed corresponding to the changed DC voltage, from a sum of a motor current, which is immediately after the changed DC voltage is applied to the DC motor, and an induced current, which flows through the DC motor rotating at the corresponding speed corresponding to the DC voltage before the change, as estimated from the convergence characteristic curve; and
seventh calculating the rotation amount of the DC motor in the second period by multiplying the reference rotation amount by a ratio of the integral value of the induced current in the second period to the reference integral value.

25. The rotation amount estimation method according to claim 23, further comprising:
determining change in the DC voltage applied to the DC motor, wherein
the second estimating includes executing processing for calculating the rotation amount of the DC motor in the second period on condition that it is determined that the DC voltage has changed beyond a predetermined threshold.

26. The rotation amount estimation method according to claim 23, further comprising:
generating a pulse signal corresponding to the rotation of the DC motor based on a ripple component included in the motor current of the DC motor, wherein
the second estimating includes executing processing for calculating the rotation amount of the DC motor in the second period on condition that the rotation speed or the rotation amount of the DC motor cannot be detected from the pulse signal as generated.

27. The rotation amount estimation method according to claim 16, further comprising:
maintaining the rotation of the DC motor until calculation of the rotation amount of the DC motor in the period from when the DC voltage applied to the DC motor changes to when the rotation speed of the DC motor is regarded as having reached the corresponding speed corresponding to the changed DC voltage is completed, even when the rotation of the DC motor is instructed to stop.

28. A rotation amount estimation device configured to estimate a rotation amount of a brushed DC motor, the rotation amount estimation device comprising:
a convergence characteristic curve estimation unit configured to estimate, based on a motor current flowing through the DC motor, a convergence characteristic curve in a period from when a DC voltage applied to the DC motor changes to when a rotation speed of the DC motor is regarded as having reached a corresponding speed corresponding to the changed DC voltage, the convergence characteristic curve indicating a characteristic in which the motor current converges to a motor current corresponding to the corresponding speed;
an integral value calculation unit configured to calculate an integral value acquired by integrating an induced current flowing through the DC motor corresponding to rotation of the DC motor over the period based on the convergence characteristic curve of the motor current estimated by the convergence characteristic curve estimation unit; and
a rotation amount estimation unit configured to estimate the rotation amount of the DC motor in the period based on the integral value of the induced current calculated by the integral value calculation unit.
